(19) United States
(12) Patent Application Publication
(10) Pub. No.: US 2026/0346294 A1
(43) Pub. Date: Nov. 5, 2026

(54) Method and Coating System for Producing a Coating With an Improved Height Profile

(71) Applicant: Bayerische Motoren Werke Aktiengesellschaft, Muenchen (DE)

(72) Inventors: Christoph NOWAK, Vaterstetten (DE); Victor SCHOB, Stephanskirchen (DE)

(21) Appl. No.: 19/486,070

(22) PCT Filed: May 2, 2024
(86) PCT No.: PCT/EP2024/062037

§ 371 Date: Nov. 20, 2025

(30) Foreign Application Priority Data
May 22, 2023 (DE) 10 2023 113 291.1

(51) Int. Cl. B05C 5/02; B05D 1/26

(52) U.S. Cl. CPC B05C 5/0262; B05C 5/027; B05D 1/265; B05D 2252/02

(57) ABSTRACT

Please replace the original Abstract with the following:

A coating system and method for coating a substrate with a fluent or pasty coating material are described. A coating nozzle having a discharge opening is used to discharge the coating material. A width of the discharge opening is smaller than a target width of the coating. The discharge opening is disposed at a predetermined distance from a substrate such that the coating is produced at the target width. The substrate moves relative to the coating nozzle, and the coating material is discharged through the discharge opening in order to coat the substrate with the coating material.

### BACKGROUND AND SUMMARY

The present invention relates to a method for coating a substrate and to a correspondingly configured coating system.

Coatings can be used in many different sectors and applications, for example in making electrical or electrochemical systems, for instance fuel cells or cylindrical battery cells, in particular cylindrical cells. There already exist various coating methods in which a coating material can be, for example, sprayed onto a substrate or printed thereon or applied thereto by way of slot-die application or the like. When making such coatings, the resultant coating may be uneven. This unevenness can, for example, affect electrical behavior of a corresponding product in an uncontrolled manner and/or cause damage or defects in subsequent manufacturing steps.

A solution described by DE 10 2004 034 139 A1 is a method for making a membrane electrode assembly. Said method comprises pressing one or more proton-conducting polymer membranes and two or more electrodes together. This pressing is carried out up to a preadjustable level of compression.

Pressing can, for example, potentially achieve a certain degree of leveling of the coating. However, if the original coating is too uneven before being pressed, then problems can occur nevertheless, for example local overcompression and/or regional detachment of the coating or damage to adjacent components and/or tools due to increased pressure in the region of excessive elevation of the coating, or the like. Therefore, there continues to be a need for improvements.

It is an object of the disclosure to make it possible in a particularly simple manner to make battery cells in a particularly efficient and robust manner.

This object is achieved by the subject matter of the main claim and of the additional superordinate claim, i.e., the independent claims. Further possible embodiments of the disclosure are disclosed in the dependent claims, the description and the drawings. Features, advantages and possible embodiments set forth within the description for one of the subjects of the independent claims are to be considered at least analogously as features, advantages and possible embodiments of the respective subject of the other independent claims and of any possible combination of the subjects of the independent claims, in conjunction with or not in conjunction with one or more of the dependent claims.

The method according to the disclosure can be used for coating a substrate, i.e., for making or producing a coating of the substrate, using a flowable or pasty, i.e., spreadable, coating material. The coating material can be in particular an electrode paste for making battery cells, for instance lithium-ion battery cells. In the method according to the disclosure, a target width is specified for the coating. This can thus be, for example, the width that the coating material, or the region occupied by the coating material, is to ultimately have on the substrate. The width can be measured in a main extension plane of the coating, i.e., perpendicular to the layer thickness thereof. If the coating is applied in an ongoing process, then the width can in particular also be perpendicular to the direction in which the coating is applied or advances.

Further provided in the method according to the disclosure is a coating die, in particular a slot die, for discharging or applying the coating material onto/to the substrate. Said coating die has an exit opening or discharge opening through which the coating material exits in the direction of the substrate during operation of a corresponding coating system. The width of said exit opening or discharge opening is smaller than the specified target width of the coating. In other words, the discharge opening is thus narrower, in the main extension plane and perpendicular to the discharge direction or longitudinal direction in which the coating is applied or produced, than the target width, i.e., also narrower than the coating ultimately produced.

In a conventional coating method, the use of such a relatively narrow coating die might lead to a correspondingly relatively narrow coating, thus meaning that the target width of the coating would then not be maintained or achieved. However, in the method according to the disclosure, the discharge opening is disposed close to the substrate such that this can ultimately produce the coating of the substrate with the coating material in the specified target width. Thus, in other words, the distance between the discharge opening and the substrate, which is also referred to as coating gap, is adjusted or reduced-proceeding for example from a configuration used in conventional slot-die coating methods-to such an extent that the material flow of the coating material from the discharge opening to the substrate is widened or spread up to the target width. This is based on the finding that the size or length of the distance between the discharge opening and the substrate, i.e., the coating gap, can influence a meniscus of the coating material that forms in the coating gap, i.e., after the discharge opening. The distance between the discharge opening and the substrate that is actually set may depend, for example, on the particular coating material, in particular its viscosity or viscoelasticity and/or surface tension or the like, and on the difference between the width of the discharge opening and the target width and can be chosen or adjusted according thereto. For example, in the case of a relatively large difference between the width of the discharge opening and the target width, a relatively small distance between the discharge opening and the substrate can be set.

In a further method step of the method according to the disclosure, relative movement between the coating die, in particular its discharge opening, and the particular substrate to be coated is then produced and the coating material is discharged through the discharge opening of the coating die in order to coat the substrate with the coating material, i.e., to make or produce the coating.

Reducing the width of the discharge opening to below the target width and simultaneously bringing the discharge opening closer to the substrate, as proposed by the disclosure, makes it possible to avoid or reduce excessive edge elevations in the coating thus produced. This is especially apparent compared to a conventional coating method in which, for example, the same coating material would likewise be discharged onto the same substrate through a coating die or slot die, but with the width of the discharge opening corresponding to the target width of the coating and with the discharge opening being, for example, at such a distance from the substrate that a free-standing or free-hanging film of the coating material is formed at the discharge opening, or between it and the substrate, in the corresponding width, which can also be referred to as so-called coat hanger mode. In the case of such a conventional coating method, excessive edge elevations can form at the edges of the coating.

Such excessive edge elevations are regions of the coating in which it has an increased layer thickness, especially compared to a middle plateau region in between in which the coating can have a specified, in particular constant, target thickness. Such excessive edge elevations thus lead to an uneven surface of the coating and therefore adversely affect or reduce the quality of the coating. For example, local overcompression can occur in the region of such excessive edge elevations on subsequent compression or pressing of the coating. This can have an undesired and inhomogeneous influence on the local properties of the coating. Similarly, the excessive edge elevation cannot always be completely leveled. This can then lead to damage to materials or components applied to the coating later in the manufacturing process and/or damage to tools, for instance a calender roller, and/or to local detachment of the coating and/or to problems concerning fit in subsequent battery cell assembling and/or the like.

These problems can be avoided or reduced by the present technology. Nevertheless, it is possible in particular to retain, i.e., continue to use, previous coating materials and substrates. Similarly, it is possible to adapt or convert existing coating systems relatively easily to the method according to the disclosure. For example, with regard to reducing the distance between the discharge opening and the substrate as envisaged by the disclosure, this can be achieved by utilizing a corresponding process window of conventional coating systems. As a result, the present technology can thus achieve a quality improvement with respect to corresponding coatings in a particularly simple and efficient manner and in a way that can be implemented feasibly. Depending on the application, this can, for example, lead to greater reliability and/or robustness of a particular end product, for example a battery cell, and/or simplify or eliminate subsequent manufacturing steps, for example for reducing or removing the excessive edge elevations and/or for filling the coating with a different material or component, in the actual coating method. In addition, damage to the tools used can thus be avoided.

In a possible embodiment of the present disclosure, the coating material is applied to the substrate in blade mode, i.e., especially not in coat hanger mode. This can mean that the discharge opening is brought so close to the substrate that a free-standing or free-hanging film or curtain of the coating material does not form at the discharge opening or immediately after it. Instead, in the blade mode used here, the short distance between the discharge opening and the substrate and the viscous nature or viscosity of the coating material mean that it can be driven laterally, i.e., in the direction of the width, thus ultimately yielding the broader coating compared to the discharge opening. This allows particularly accurate, reliable and robust production of the coating in the specified target width with reduced excessive edge elevations or without excessive edge elevations and therefore thus in correspondingly improved quality, for example compared to applying the coating material to the substrate in coat hanger mode.

In a further possible embodiment of the present disclosure, the discharge opening is disposed at a distance of less than 200 μm, in particular less than 100 μm, from the substrate. In other words, the size or length of the coating gap may thus be in the two-digit micrometer range. It has been found that this makes it possible to produce a coating at least substantially without excessive edge elevations, especially when using an electrode paste as the coating material, for example for making battery cells, in particular cylindrical battery cells.

In a further possible embodiment of the present disclosure, a volumetric flow rate of the coating material that is used, i.e., specified, for example set on a corresponding coating system for discharging the coating material, is one that will produce the coating in the target width with a central layer thickness that would also arise for the same coating material in the case of a discharge opening corresponding in terms of its width to the target width and in the case of a greater distance between the discharge opening and the substrate. In other words, the same volumetric flow rate of the coating material as in the case of a conventional coating method or a conventional coating system or coating system configuration can thus be used here for the same coating or the same kind of coating.

The central layer thickness of the coating is present in its middle region as viewed in the direction of the width, i.e., a plateau region of the coating between its edges or possible edge effects, for instance a conventionally occurring excessive edge elevation and/or a gradually descending outer border or the like. Said central layer thickness can in particular be specified as a parameter, i.e., as a target layer thickness or target thickness.

Proceeding from a conventional coating method or coating process, it has been found that by merely reducing the width of the discharge opening and the distance between the discharge opening and the substrate while simultaneously retaining the target width, the coating material and its volumetric flow rate, the coating can be made in the specified target width and target thickness together with improved quality, especially with respect to excessive edge elevation. As a result, the method according to the disclosure can moreover be integrated into existing manufacturing processes in a particularly simple and effortless manner.

The present disclosure also relates to a coating system for coating a substrate with a coating material, in particular an electrode paste. The coating system according to the disclosure can in particular be or correspond to the coating system mentioned in connection with the method according to the disclosure. The coating system according to the disclosure thus comprises the coating die, especially in the form of a slot die, having the discharge opening for discharging the coating material. Moreover, the coating system according to the disclosure comprises a transport or movement mechanism for producing the relative movement between the coating die, in particular the discharge opening thereof, and the particular substrate to be coated. As a result, the particular substrate can in particular be moved relative to the coating die or the discharge opening thereof, for example past it. To this end, the movement mechanism may be or comprise, for example, a deflection roll or roller or a conveyor belt or the like. The coating die may in particular be disposed or remain in a fixed position relative to the environment. Similarly, another embodiment in which only the coating die is actively moved or the coating die is also actively moved may be possible in principle. The coating system according to the disclosure is configured for the method according to the disclosure, i.e., for carrying out the method according to the disclosure or for use in the method according to the disclosure. This can mean, for example, that the coating die or the discharge opening thereof and the distance between the discharge opening and the movement mechanism, in particular a surface or a region of the movement mechanism on which the substrate to be coated rests or is moved during operation, is designed or set accordingly. The coating system may similarly comprise further components, for example a conveyor mechanism for conveying the coating material into or through the coating die and/or an adjustment mechanism for adjusting the distance between the coating die and the substrate and/or the like.

In a further possible embodiment of the present disclosure, the width of the discharge opening is smaller than the width of the coating produced, i.e., smaller than the corresponding specified target width, by at most 2%, in particular by at most 1%. This has been found to be a feasible and effective parameterization, in particular for an electrode paste, for avoiding the formation of excessive edge elevations in the coating and for simultaneously producing the coating in the greater target width compared to the width of the discharge opening. This is based on the finding that the properties of the coating and the behavior of the coating material can be rather sensitive in their dependence on parameters such as the width of the discharge opening or the difference between the width of the discharge opening and the target width as well as on the distance between the discharge opening and the substrate.

In a further possible embodiment of the present disclosure, the width of the discharge opening is smaller than the width of the coating produced, i.e., smaller than the specified target width, by between 0.2 mm and 2.5 mm. In particular, the difference between the width of the discharge opening and the width of the coating produced or the target width may be between 0.5 mm and 1 mm. This can thus mean in particular that the coating gap has been or is adjusted accordingly as well. It has been found that this is a feasible and effective parameterization especially for an electrode paste for making, for example, lithium-ion electrodes and battery cells. At the same time, the width of the coating produced, i.e., the specified target width, may be, for example, about 160 mm.

In a further possible embodiment of the present disclosure, the coating die comprises at least one exchangeable insert mask by way of which the width of the discharge opening is defined or has been brought about, i.e., is set or realized. Such an insert mask can also be referred to as a shim or shim plate. The insert mask can thus, for example, be or have been inserted into a housing of the coating die in order to reduce its opening on the outlet side. To this end, the insert mask can comprise, for example, a free region which ultimately forms the discharge opening and one or more material regions next to it which delimit the space available for the coating material. Such an insert mask thus makes it possible, for example, for an existing coating die having a relatively large outlet-side opening to be adjusted for the method according to the disclosure. Since the insert mask is exchangeable, the same coating die or the same coating die housing can be adapted to different requirements, target widths, coating materials and/or the like in a particularly simple manner. As a result, the advantages of the present disclosure can thus be realized or utilized in a particularly simple and flexible manner.

In a further possible embodiment of the present disclosure, the coating die comprises multiple mutually adjacent separate discharge openings for simultaneously producing multiple parallel coatings. In other words, the coating die can thus simultaneously discharge multiple parallel material streams of the coating material. The coating die may in particular comprise exactly two or at least two such separate discharge openings. The discharge openings are mutually adjacent in the direction of the width. The multiple parallel coatings can thus be produced in the same plane. Since the discharge openings are separate from one another, this can mean that they are separated, i.e., spaced from one another, by an intermediate region in which or through which no coating material can be discharged during operation. To this end, the coating die can be disposed, for example, multiple insert masks or one insert mask defining, i.e., realizing or delimiting, the multiple discharge openings.

The presently proposed embodiment of the coating die allows the production of multiple coatings, i.e., multiple separate strips or regions of coating material applied to the/a particular substrate, in a particularly simple and efficient manner. Said coatings can be produced in a particularly consistent manner, i.e., in an identical manner or with identical properties. In particular, the distance of the coating die from the substrate(s) can then be automatically identical for both coatings or all coatings. This can likewise contribute to improved quality and/or reduced component variation in mass production.

In a possible development of the present disclosure, the individual width of each of the discharge openings of the coating die is, in each case, smaller than the coating thus produced, i.e., for example smaller than a respective individually specified target width. The discharge openings may all be of identical width or at least two of the discharge openings may differ in width. As a result, the/all the simultaneously produced coatings can be produced in the described manner, i.e., especially at least substantially without an excessive edge elevation. The presently proposed embodiment of the present disclosure thus allows the simultaneous production of multiple coatings of corresponding high quality. At the same time, the multiple coatings can be produced especially flexibly, since, for example, different widths can be provided or realized for the discharge openings.

Further features of the technology can be found in the claims, the drawings, and the description of the drawings. The features and combinations of features stated above in the description and the features and combinations of features shown hereinbelow in the description of the drawings and/or in the drawings alone are usable not only in the respective specified combination, but also in other combinations or in isolation, without departing from the scope of the technology.

### BRIEF DESCRIPTION OF THE DRAWINGS

The drawings show in:

FIG. 1 a schematic lateral illustration of a height profile of a coating produced according to the prior art;

FIG. 2 a coating line for producing an improved coating;

FIG. 3 a schematic sectional illustration for illustrating a possible embodiment of a coating die of the coating line; and

FIG. 4 a schematic lateral illustration of possible height profiles of the improved coating.

In the drawings, identical and functionally identical elements are provided with identical reference signs.

### DETAILED DESCRIPTION OF THE DRAWINGS

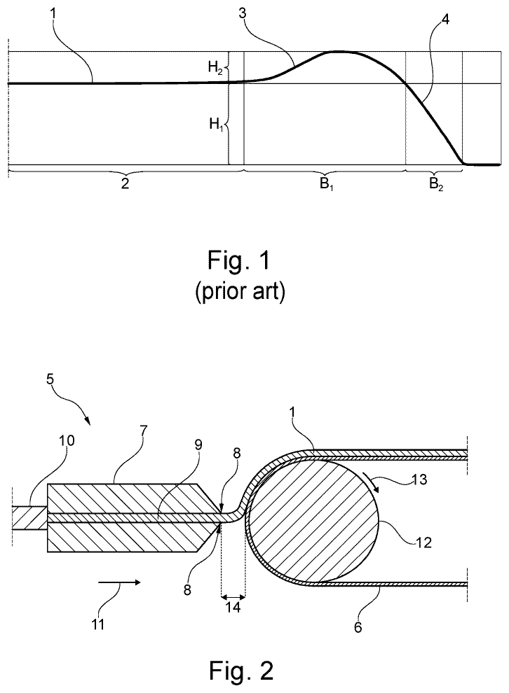

FIG. 1 shows a detail of a schematic cross-sectional illustration for illustrating a course or profile of a surface of a coating 1 according to the prior art, i.e., for example when using a conventional slot-die coating method. In particular, it shows an outer portion of a central plateau region 2 and an adjacent edge region of the coating 1. In the plateau region 2, the coating 1 has its layer thickness H1, which is specified as a target. By contrast, the plateau region 2 is followed in the edge region by a region which is at least regionally elevated, i.e., thickened, in comparison and in which the coating 1 has an excessive edge elevation 3. Compared to the nominal layer thickness H1, said excessive edge elevation 3 has an additional, i.e., extra, excessive-edge-elevation thickness H2. On the outer side or edge side thereof, the excessive edge elevation 3 is followed by a descending flank, which is referred to here as edge-descent border 4. The edge-descent border 4 starts where the excessive edge elevation 3 ends, i.e., the thickness of the coating 1 falls to below the nominal layer thickness H1. The width of the excessive edge elevation 3 is referred to here as excessive-edge-elevation width B1, whereas the width of the edge-descent border 4 is referred to here as edge-descent width B2. The sum total of the excessive-edge-elevation width B1 and the edge-descent width B2 can thus be understood as the width of the edge region that adjoins the plateau region 2.

In the present case, only a portion of the coating 1 or profile of the coating 1 is shown. Thus, on its other edge that is not shown here, the coating 1 can likewise have an excessive edge elevation 3 and an adjacent edge-descent border 4. The plateau region 2 in between can be substantially broader than the two edge regions.

In many technical applications, it is technically advantageous to minimize the excessive edge elevation 3, for example when making electrodes, in which the coating 1 may for example be formed of an electrode paste.

For the coating 1, a target width is specified. In the prior art, a width of an outlet-side opening of a die for producing the coating 1, i.e., for discharging a corresponding coating material, can correspond to this target width. However, as a result, the excessive edge elevation 3 can arise or appear at the outer edges or in the edge regions of the coating 1.

For example, the process of coating electrodes for lithium-ion cells involves the application of the electrode paste, which is or contains an active electrochemical material, to a metallic collector film. The edge region of the corresponding coating 1 thus corresponds to a region of transition from the coating material—i.e., the electrode paste here—to the collector film after the coating material has been applied to the collector film, i.e., after it has been discharged thereon. An ideal geometry in the edge region would be a respective right-angled transition from the plateau region 2 to the edge-descent border 4 and from the latter to the collector film, i.e., an edge-descent border 4 which is perpendicular to the main extension plane of the collector film and thus typically to the width of the coating 1 as well.

However, this is not realistically achievable when using typically flowable or pasty coating materials, for example an electrode paste. The actual geometry of the coating 1 in the edge region can therefore be characterized by two quality features. The quality features are, firstly, the excessive-edge-elevation thickness H2 and, secondly, the edge-descent width B2. A lower excessive-edge-elevation thickness H2 and a narrower edge-descent width B2 mean the coating 1 is of higher quality.

FIG. 2 shows a detail of a schematic cross-sectional illustration of a coating system 5. Here, the coating system 5 can be configured, for example, for coating a substrate 6, for example one that is in the form of film, with the coating 1, i.e., for example an electrode paste. As application tool for the corresponding coating material, the coating system 5 comprises a coating die 7. It can in particular be in the form of a slot die; here, the longitudinal extension direction of a corresponding outlet-side slot-type discharge opening 8 of the coating die 7 can be perpendicular to the plane of the drawing and perpendicular to a presently indicated discharge direction 11 of the coating material. Formed in the coating die 7 is a transport or conveyor channel 9 for the coating material. It is through said conveyor channel 9 that the coating material in the coating die 7 can be guided, for example, from an inlet-side material feed 10, indicated here only rudimentarily, in the discharge direction 11 up to the outlet-side discharge opening 8 of the coating die 7. There, the coating material can exit or be discharged from the coating die 7 in the direction of the substrate 6 in order to produce the coating 1.

During operation of the coating system 5, the substrate 6 can be moved relative to the discharge opening 8, in particular past it, in order to produce the coating 1 on the substrate 6. To this end, the coating system 5 comprises a corresponding transport or movement mechanism, which is indicated here in the form of an application roller 12 by way of example. During operation, said application roller 12 can rotate in a direction of rotation 13, which is indicated, and thereby move the substrate 6, which is guided on or at the application roller 12, past the discharge opening 8.

Now, in order to avoid the undesired formation of the excessive edge elevation 3 of the coating 1, two measures are proposed. Firstly, a given distance, indicated here as coating gap 14, between the discharge opening 8 and the substrate 6 or application roller 12 is reduced, compared to a conventional slot-die coating method, in order to avoid the excessive edge elevation 3 and to observe the target width specified for the particular coating 1.

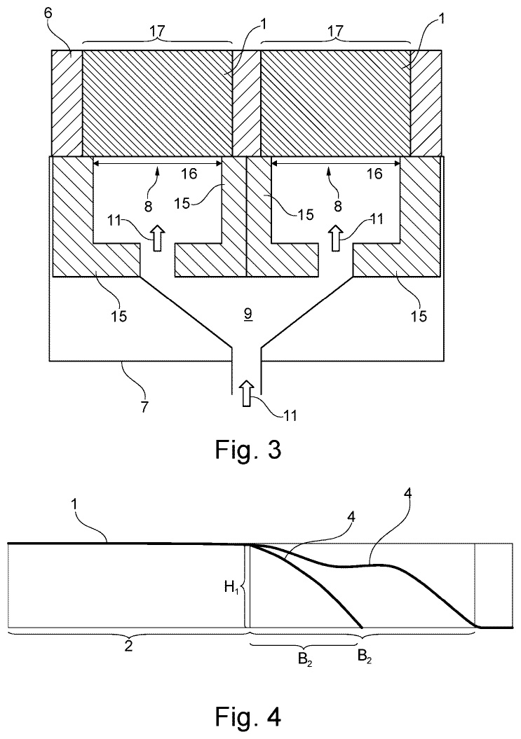

Secondly, the width of the discharge opening 8—i.e., its longitudinal extension perpendicular to the plane of the drawing in FIG. 2—is smaller than the target width specified for the particular coating 1. In relation to this, FIG. 3 shows a detail of an example schematic sectional illustration of the coating die 7 and, disposed on the outlet side thereof, a region of the substrate 6 having an already produced portion of the coating 1. In the present case, the coating die 7 is configured for the parallel production of two coatings 1 side by side. This is achieved by disposing in the coating die 7 two insert masks 15 that each define, i.e., surround or free, a corresponding discharge opening 8. Said discharge openings 8 each have a free opening width 16. The opening width 16 shown here in the plane of the drawing would thus, in the illustration in FIG. 2, be perpendicular to the plane of the drawing in said figure. Here, the opening widths 16 are smaller than the layer widths 17 of the coatings 1 thus ultimately yielded, i.e., smaller than their specified target width(s).

The combination of this narrower design of the opening widths 16, i.e., the reduction of the particular opening width 16 to below the target width specified for the particular coating 1, and the simultaneous reduction of the coating gap 14 makes it possible to produce the coating 1 in the specified target width and without excessive edge elevations 3.

For example, the layer width 17, i.e., the target width specified for the particular coating 1, may be 160 mm here. The particular opening width 16 may be smaller than this target width, i.e., smaller than the layer width 17, by 0.8 mm for example. The coating gap 14 may be reduced or adjusted at the same time to, for example, less than 100 μm. For example, depending on the target width and depending on the coating material used, the coating gap 14 can be gradually reduced until the layer width 17 corresponds to the specified target width. The ultimate size of the coating gap 14 can be, for example, determined or defined by way of experiments and/or simulations.

Analogously to the illustration in FIG. 1, FIG. 4 shows an illustration for illustrating two possible courses or profiles of the surface of the coating 1 when the described measures are applied. Here too, the coating 1 has the specified layer thickness H1 in the central plateau region 2. Outwardly, i.e., on the edge side thereof, this is, however, directly followed by the edge-descent border 4 without any excessive edge elevation 3. Two possible courses of the edge-descent border 4 having correspondingly different edge-descent widths B2 are shown here by way of example. This serves to illustrate that the edge-descent width B2, compared to conventional slot-die coating methods which additionally yield the excessive edge elevation 3 having the excessive-edge-elevation width B1 as shown in FIG. 1, need not necessarily increase, i.e., need not necessarily worsen the quality of the coating 1 with respect to this quality feature.

In the illustrations according to FIG. 1 and FIG. 4, the sizes of the excessive-edge-elevation width B1 and of the edge-descent width B2 may be, for example, in the range of less than 10 mm or less than 5 mm. In contrast, the width of the plateau region 2 shown only as a detail in each case may thus be many times larger.

Altogether, the described examples show how a shim or insert-mask design for dies, in particular slot dies, can be realized and used for minimizing excessive elevations on edges in coating processes, in particular those for coating electrodes for lithium-ion cells.

### REFERENCE SIGNS

1 coating
2 plateau region
3 excessive edge elevation
4 edge-descent border
5 coating system
6 substrate
7 coating die
8 discharge opening
9 conveyor channel
10 material feed
11 discharge direction
12 application roller
13 direction of rotation
14 coating gap
15 insert mask
16 opening width
17 layer width
H1 layer thickness
H2 excessive-edge-elevation thickness
B1 excessive-edge-elevation width
B2 edge-descent width

1-10. (canceled)

11. A method for coating a substrate with a flowable or pasty coating material, the method comprising:
specifying a target width for a coating;
providing a coating die including a discharge opening having a width smaller than the target width of the coating,
disposing the discharge opening at a predetermined distance from a substrate;
moving the substrate relative to the coating die; and
discharging coating material through the discharge opening as the substrate moves relative to the coating die, thereby applying the coating material to the substrate to produce the coating.

12. The method according to claim 11,
wherein
the coating material is applied to the substrate in blade mode.

13. The method according to claim 11,
wherein
the predetermined distance from the substrate is less than 200 μm.

14. The method according to claim 13,
wherein
the predetermined distance from the substrate is less than 100 μm.

15. The method according to claim 11,
wherein
a volumetric flow rate of the coating material during discharging is selected to produce the coating in the target width and having a predetermined central layer thickness (H1).

16. The method according to claim 15,
wherein
the predetermined central layer thickness (H1) corresponds to that attainable from discharging the same coating material through another discharge opening having a larger width matching the target width and being disposed at a larger predetermined distance from the substrate.

17. The method according to claim 11,
wherein
the width of the discharge opening is smaller than a width of the coating produced by at most 2%.

18. The method according to claim 17,
wherein
the width of the discharge opening is smaller than the width of the coating produced by at most 1%.

19. The method according to claim 11,
wherein
the width of the discharge opening is smaller than a width of the coating produced by between 0.2 mm and 2.5 mm.

20. The method according to claim 19,
wherein
the width of the discharge opening is smaller than the width of the coating produced by between 0.5 mm and 1 mm.

21. The method according to claim 11,
wherein
the coating die comprises an exchangeable insert mask to define the width of the discharge opening.

22. The method according to claim 11,
wherein
the coating die comprises multiple mutually adjacent separate discharge openings for simultaneously producing multiple parallel coatings.

23. A coating system for coating a substrate with a coating material, the coating system comprising:
a coating die having a discharge opening for discharging a coating material; and
a movement mechanism for producing relative movement between a substrate to be coated and the coating die.

24. The coating system according to claim 23,
wherein
a width of the discharge opening is smaller than a width of a coating produced by at most 2%.

25. The coating system according to claim 24,
wherein
the width of the discharge opening is smaller than the width of the coating produced by at most 1%.

26. The coating system according to claim 23,
wherein
a width of the discharge opening is smaller than a width of the coating produced by between 0.2 mm and 2.5 mm.

27. The coating system according to claim 26,
wherein
the width of the discharge opening is smaller than the width of the coating produced by between 0.5 mm and 1 mm.

28. The coating system according to claim 23,
wherein
the coating die comprises an exchangeable insert mask to define a width of the discharge opening.

29. The coating system according to claim 23,
wherein
the coating die comprises multiple mutually adjacent separate discharge openings for simultaneously producing multiple parallel coatings.

30. The coating system according to claim 29,
wherein
an individual width of each of the discharge openings of the coating die is smaller than a width of the respective coating produced.
